(19) United States
(12) Patent Application Publication
(10) Pub. No.: US 2024/0193730 A1
(43) Pub. Date: Jun. 13, 2024

(54) INFORMATION PROCESSING APPARATUS, INFORMATION PROCESSING METHOD, AND INFORMATION PROCESSING PROGRAM

(71) Applicant: SONY SEMICONDUCTOR SOLUTIONS CORPORATION, KANAGAWA (JP)

(72) Inventor: TAKAFUMI SHOKONJI, KANAGAWA (JP)

(21) Appl. No.: 18/551,364

(22) PCT Filed: Feb. 15, 2022
(86) PCT No.: PCT/JP2022/005882

§ 371 Date: Sep. 19, 2023

(30) Foreign Application Priority Data
Mar. 31, 2021 (JP) 2021-060547

(51) Int. Cl. G06T 3/4053; G06T 7/00; G06T 7/50; G06T 7/60; G06V 20/58; G06V 20/62

(52) U.S. Cl. CPC G06T 3/4053; G06T 7/0002; G06T 7/50; G06T 7/60; G06V 20/58; G06V 20/625; G06T 2207/30168; G06T 2207/30252; G06V 2201/08

(57) ABSTRACT

[Object] To calculate a distance between vehicles traveling on a road accurately and with a low load.

[Solving Means] An information processing apparatus includes: a candidate area detection unit that detects a candidate area including a specific object from an environment image acquired by an imaging apparatus; a target area extraction unit that extracts a target area from the candidate area, the target area being a target of super-resolution processing; and a super-resolution processing unit that generates a super-resolution image by performing super-resolution processing on the target area.

### TECHNICAL FIELD

The present disclosure relates to an information processing apparatus, an information processing method, and an information processing program that calculate a distance between vehicles traveling on a road.

### BACKGROUND ART

With the increasing demand for vehicle safety in advanced driver-assistance systems (ADAS) and the development of automated driving vehicle technology, a technology for measuring a distance and a positional relationship between vehicles traveling on a road is being explored.

### CITATION LIST

### Patent Literature

Patent Literature 1: Japanese Patent Application Laid-open No. 2009-49979

Patent Literature 2: Japanese Patent Application Laid-open No. 2020-72457

### DISCLOSURE OF INVENTION

### Technical Problem

It is desirable to perform information processing accurately and with a low load in a technology for measuring a distance and a positional relationship between vehicles traveling on a road.

In view of the circumstances as described above, it is an object of the present disclosure to provide a technology for calculating a distance between vehicles traveling on a road accurately and with a low load.

### Solution to Problem

An information processing apparatus according to an embodiment of the present disclosure includes:
a candidate area detection unit that detects a candidate area including a specific object from an environment image acquired by an imaging apparatus;
a target area extraction unit that extracts a target area from the candidate area, the target area being a target of super-resolution processing; and
a super-resolution processing unit that generates a super-resolution image by performing super-resolution processing on the target area.

In order to extract a specific object from an environment image and accurately calculate the size of the object, a method of performing super-resolution processing on the entire environment image is conceivable. However, the amount of calculation for super-resolution processing is enormous, and there are problems of a processing load and a processing speed. Meanwhile, in this embodiment, the information processing apparatus extracts a target area from the environment image and performs super-resolution processing on the target area instead of the entire environment image. As a result, it is possible to suppress an increase in processing load and suppress a decrease in processing speed.

The target area extraction unit may
determine whether or not a distance to the object is equal to or greater than a threshold value, and
extract, upon determining that the distance is equal to or greater than the threshold value, the target area from the candidate area.

In this embodiment, the information processing apparatus extracts an object at a relatively long distance as a target area for super-resolution processing. This is because an object at a relatively short distance is relatively sharp in the environment image, and thus, there is a high possibility that the object can be accurately extracted from an environment image with a relatively low resolution without performing super-resolution processing. As a result, it is possible to further suppress an increase in processing load and a decrease in processing speed.

The threshold value may be variable, and
the target area extraction unit may set the threshold value on the basis of environment information of surroundings of the imaging apparatus.

In this embodiment, the information processing apparatus variably sets, on the basis of the environment information, the threshold value of the distance for extracting the target area from the candidate area. As a result, the information processing apparatus is capable of ensuring the safety in a scene where the image quality of the environment image is estimated to be low while suppressing, in a scene where the image quality of the environment image is estimated to be high, an increase in processing load and a decrease in processing speed.

The environment information may indicate weather, illuminance, and/or luminance.

In this embodiment, the information processing apparatus is capable of ensuring the safety in a scene where the image quality of the environment image is estimated to be low (nighttime, rainy weather, or the like) while suppressing, in a scene where the image quality of the environment image is estimated to be high (daytime, fine weather, or the like), an increase in processing load and a decrease in processing speed.

The target area extraction unit may
set, where image quality of the environment image is estimated to be low on the basis of the environment information, a first threshold value as the threshold value, and
set, where the image quality is not estimated to be low, a second threshold value larger than the first threshold value as the threshold value.

In this embodiment, the information processing apparatus variably sets, on the basis of the environment information, the threshold value of the distance for extracting the target area from the candidate area. As a result, the information processing apparatus performs super-resolution processing on an object at a relatively short distance in a scene where the image quality of the environment image is estimated to be low. Meanwhile, the information processing apparatus does not perform super-resolution processing on an object at a relatively short distance in a scene where the image quality of the environment image is estimated to be high. As a result, it is possible to ensure the safety in a scene where the image quality of the environment image is estimated to be low while suppressing, in a scene where the image quality of the environment image is estimated to be high, an increase in processing load and a decrease in processing speed.

The object may be at least part of a vehicle, and
the target area may include a license plate of the vehicle.

The size of the license plate and/or the size of the characters on the license plate are smaller than the size of the back surface of the vehicle. For this reason, it is difficult to extract a license plate and/or characters of the license plate from the environment image and calculate the size accurately in some cases for distance vehicles or vehicles at a relatively short distance depending on the weather and the timeframe. Meanwhile, in this embodiment, the information processing apparatus extracts, as a target area, the minimum area including only the license plate as much as possible from the environment image instead of the entire environment image, and performs super-resolution processing thereon. As a result, it is possible to extract a license plate and/or characters of the license plate and calculate the size accurately while suppressing an increase in processing load and a decrease in processing speed.

The target area may include a license plate of a neighboring vehicle that is a vehicle traveling in the same driving lane as that of the specific vehicle or an adjacent lane.

In this embodiment, the information processing apparatus does not extract all license plates as a target area for super-resolution processing, but extracts a license plate of a neighboring vehicle as a target area for super-resolution processing. This is because a vehicle does not execute automatic braking or the like directly due to a vehicle traveling in a lane distant from the adjacent lane (distant vehicle). In other words, it is after the distant vehicle moves to the adjacent lane and is regarded as a neighboring vehicle that the vehicle executes automatic braking or the like directly due to the distant vehicle. For this reason, it is unnecessary to perform super-resolution processing on the license plate of the distant vehicle. As a result, it is possible to further suppress an increase in processing load and a decrease in processing speed.

The target area extraction unit may determine, as a distance to the object, whether or not a distance from the specific vehicle to the neighboring vehicle is equal to or greater than the threshold value.

The information processing apparatus is capable of executing automated driving or executing automatic braking or the like in non-automated driving by calculating the distance between the specific vehicle and the neighboring vehicle.

The information processing apparatus may further includes:
a license plate judgment unit that judges, on the basis of the super-resolution image generated by the super-resolution processing unit, a size of the license plate of the neighboring vehicle and/or a size of characters of the license plate; and
a distance calculation unit that calculates a distance between the specific vehicle and the neighboring vehicle on the basis of the size.

The information processing apparatus judges the size of the license plate of the neighboring vehicle and/or the size of the characters on the license plate, and calculates a distance from the vehicle to the neighboring vehicle on the basis of the judged size. The size of the vehicle varies depending on the respective types, but the size of the license plate and/or the size of the characters on the license plate are uniformly defined by standards. For this reason, by detecting the size of the license plate of the neighboring vehicle and/or the size of the characters on the license plate, it is possible to calculate the distance from the vehicle to the neighboring vehicle.

The target area extraction unit may refrain, upon determining that the distance to the object is less than the threshold value, from extracting the target area from the candidate area,
the license plate judgment unit may judge a size of the license plate of the neighboring vehicle and/or a size of characters of the license plate included in the candidate area, and
the distance calculation unit calculates a distance between the specific vehicle and the neighboring vehicle on the basis of the size.

In this embodiment, the information processing apparatus does not extract license plates of all neighboring vehicles as a target area for super-resolution processing, but extracts a license plate of a neighboring vehicle at a relatively long distance as a target area for super-resolution processing. This is because a license plate of a neighboring vehicle at a relatively short distance is relatively sharp in the environment image, and thus, there is a high possibility that the license plate can be accurately extracted from an environment image with a relatively low resolution without performing super-resolution processing. As a result, it is possible to further suppress an increase in processing load and a decrease in processing speed.

The candidate area detection unit may periodically detect the candidate area at first timing, and
the target area extraction unit may periodically extract the target area at second timing that is less frequent than the first timing.

When the target area extraction unit periodically detects the target area at the second timing of a relatively low frequency, it is possible to suppress an increase in processing load and a decrease in processing speed.

The super-resolution processing unit may periodically generate the super-resolution image at the second timing.

When the super-resolution processing unit periodically executes super-resolution processing at the second timing of a relatively low frequency, it is possible to suppress an increase in processing load and a decrease in processing speed.

The imaging apparatus may be a monocular camera.

Although the monocular camera has lower performance than a stereo camera or the like, it is possible to improve, by performing super-resolution processing on a necessary target area, the accuracy of distance calculation while using an environment image of the monocular camera with a low processing load.

The specific vehicle may include the information processing apparatus and the imaging apparatus.

In this embodiment, a distance to a neighboring vehicle traveling in front of or in the vicinity of a specific vehicle or a positional relationship can be measured, which can contribute to the increasing demand for vehicle safety in an advance driving support system.

The specific vehicle may be an automated driving vehicle.

In this embodiment, a distance to a neighboring vehicle traveling in front of or in the vicinity of a specific vehicle or a positional relationship can be measured, which can contribute to the automated driving.

The information processing apparatus and the imaging apparatus may be provided in a roadside unit.

In this embodiment, the imaging apparatus provided in the roadside unit only needs to image a specific vehicle and a neighboring vehicle to acquire an environment image, and the information processing apparatus provided in the roadside unit only needs to calculate, from the environment image, the distance between the specific vehicle and the neighboring vehicle. The data can be used for safety purposes, such as verification of accidents in the field. Further, it can also contribute to the increasing demand for vehicle safety in an advance driving support system and automated driving.

An information processing method according to an embodiment of the present disclosure includes:
extracting a candidate area including a specific object from an environment image acquired by an imaging apparatus;
extracting a target area from the candidate area, the target area being a target of super-resolution processing; and
generating a super-resolution image by performing super-resolution processing on the target area.

An information processing program according to an embodiment of the present disclosure causes a processor of an information processing apparatus to operate as:
a candidate area detection unit that detects a candidate area including a specific object from an environment image acquired by an imaging apparatus;
a target area extraction unit that extracts a target area from the candidate area, the target area being a target of super-resolution processing; and
a super-resolution processing unit that generates a super-resolution image by performing super-resolution processing on the target area.

### BRIEF DESCRIPTION OF DRAWINGS

FIG. 1 shows a functional configuration of an information processing apparatus according to an embodiment of the present disclosure.

FIG. 2 shows an operation flow of the information processing apparatus.

FIG. 3 schematically shows an example of a candidate area detected from an environment image.

FIG. 4 schematically shows another example of the candidate area detected from the environment image.

FIG. 5 is a diagram for describing a first threshold value and a second threshold value.

FIG. 6 schematically shows processing timings of a candidate area detection unit, a target area extraction unit, and a super-resolution processing unit.

### MODE(S) FOR CARRYING OUT THE INVENTION

An embodiment of the present disclosure will be described below with reference to the drawings.

### 1. Functional Configuration of Information Processing Apparatus

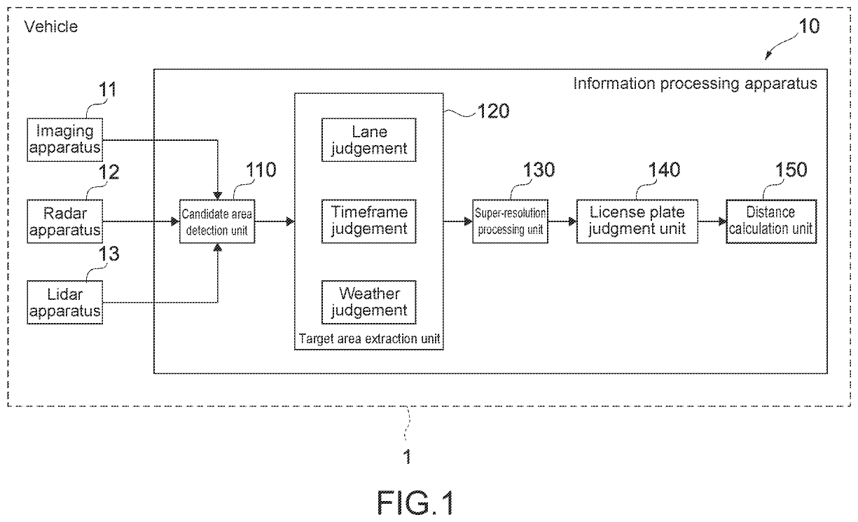

FIG. 1 shows a functional configuration of an information processing apparatus according to an embodiment of the present disclosure.

An information processing apparatus 10 is mounted on, for example, a vehicle 1. The vehicle may be an automated driving vehicle or a non-automated driving vehicle. The vehicle 1 includes at least an imaging apparatus 11 and may further include a radar apparatus 12 (Radar: Radio Detecting and Ranging) and/or a lidar apparatus 13 (LiDAR: Light Detection and Ranging).

The imaging apparatus 11 is, for example, a monocular camera, but may be another camera (stereo camera or the like). The imaging apparatus 11 constantly images the environment in front of the vehicle 1 to acquire an environment image. In the following description, the environment in front of the vehicle 1 means, in the case where the vehicle 1 is traveling on a road, an environment including a driving lane in which the vehicle 1 travels, an adjacent lane adjacent to the driving lane (an oncoming lane and/or a lane in the same traveling direction where there is no median strip), still another lane, a sidewalk, a vehicle and pedestrian on a road, a building, and the like.

The radar apparatus 12 emits a radio wave, measures the time it takes to receive the reflected radio wave, measures the distance and direction to an object (vehicle or the like) present in the environment in front of the vehicle 1, and constantly generates ranging information represented by a color tone or a function.

The lidar apparatus 13 emits a laser beam, measure the time it takes to receive the reflected laser beam, measures the distance and direction to an object (vehicle or the like) present in the environment in front of the vehicle 1, and constantly generates ranging information represented by a color tone or a function.

The information processing apparatus 10 operates, when a CPU (processor) loads an information processing program recorded on a ROM into a RAM and executes the program, as a candidate area detection unit 110, a target area extraction unit 120, a super-resolution processing unit 130, a license plate judgment unit 140, and a distance calculation unit 150.

In order to execute automated driving or execute automatic braking or the like in non-automated driving, the information processing apparatus 10 calculates the distance between the vehicle 1 (referred to as a specific vehicle in some cases) and a neighboring vehicle (vehicle traveling in the same driving lane as that of a specific vehicle 1 or an adjacent lane). Specifically, the information processing apparatus 10 judges the size of the license plate of the neighboring vehicle and/or the size of the characters on the license plate, and calculates the distance from the vehicle 1 to the neighboring vehicle on the basis of the judged size. The size of the vehicle varies depending on the respective types, but the size of the license plate and/or the size of the characters on the license plate are uniformly defined by standards. For this reason, by detecting the size of the license plate of the neighboring vehicle and/or the size of the characters on the license plate, it is possible to calculate the distance from the vehicle 1 to the neighboring vehicle.

Meanwhile, the size of the license plate and/or the size of the characters on the license plate are smaller than the size of the back surface of the vehicle. For this reason, it is difficult to extract a license plate and/or characters of the license plate from the environment image and calculate the size accurately in some cases for distance vehicles or vehicles at a relatively short distance depending on the weather and the timeframe.

In view of the circumstances as described above, the information processing apparatus 10 according to this embodiment aims to calculate the distance between the vehicle 1 and the neighboring vehicle accurately and with a low load.

### 2. Operation Flow of Information Processing Apparatus

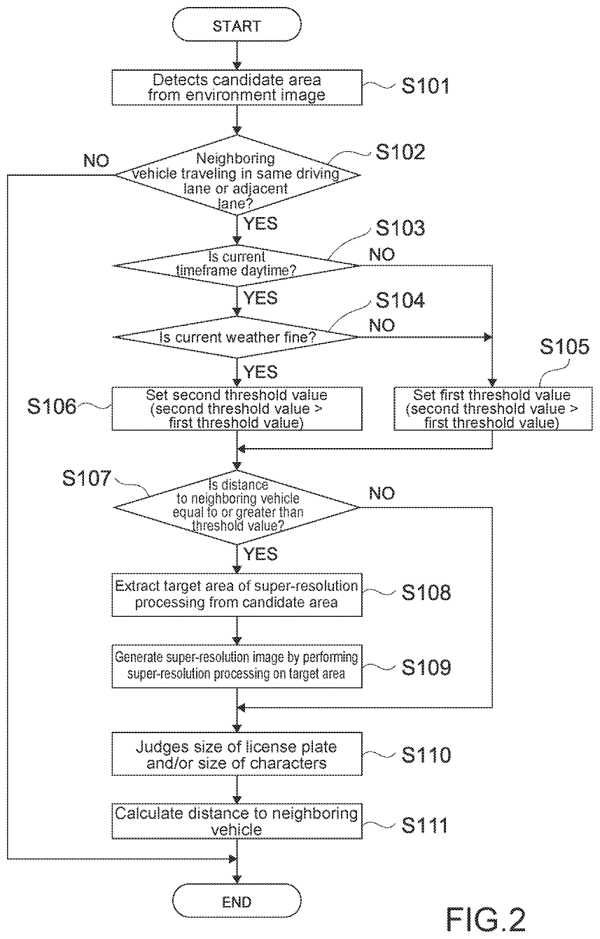

FIG. 2 shows an operation flow of the information processing apparatus.

The candidate area detection unit 110 acquires the environment image that the imaging apparatus 11 constantly acquires. The candidate area detection unit 110 detects a candidate area from the environment image (Step S101). Note that in the case where the vehicle 1 includes the radar apparatus 12 and/or the lidar apparatus 13, the candidate area detection unit 110 further acquires the ranging information that the radar apparatus 12 and/or the lidar apparatus 13 constantly generate. The candidate area detection unit 110 detects a candidate area from the environment image with high accuracy by fusing the environment image and the ranging information.

The candidate area is an area including a specific object. The specific object includes at least part of the vehicle. For example, the specific object may be the entire vehicle, the license plate of the vehicle, or another part of the vehicle (a headlamp, a taillamp, a wing mirror, or the like). The candidate area detection unit 110 periodically detects a candidate area at first timing.

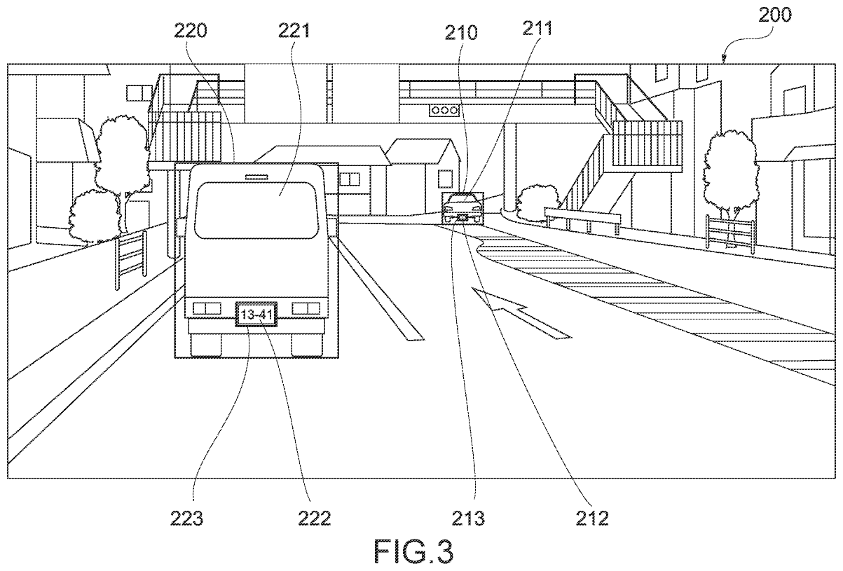

FIG. 3 schematically shows an example of the candidate area detected from the environment image.

The candidate area detection unit 110 detects candidate areas 210 and 220 from an environment image 200. The candidate areas 210 and 220 respectively include vehicles 211 and 221. The candidate areas 210 and 220 respectively are rectangular regions including the vehicles 211 and 221. Note that the candidate area detection unit 110 extracts all candidate areas including a vehicle from the environment image 200 regardless of the position and distance of the vehicle. Specifically, the candidate area detection unit 110 extracts all candidate areas including a vehicle traveling in a driving lane in which the vehicle 1 travels, an adjacent lane adjacent to the driving lane (an oncoming lane and/or a lane in the same traveling direction where there is no median strip), or still another lane.

The target area extraction unit 120 extracts a target area (ROI: Region of Interest) from the candidate area (Step S102 to Step S108). The target area includes the license plate of the vehicle. More specifically, the target area extraction unit 120 extracts the license plate of the vehicle from the candidate area by edge detection, and treats the extracted area as a target area. In other words, the target area is the minimum area including only the license plate as much as possible. The target area is a region that is a target of super-resolution processing. The super-resolution processing is a technology for generating a high-resolution image from a low-resolution image. For example, a technology for generating a high-resolution image by synthesizing a plurality of low-resolution images that is continuous in time series and a technology for generating a high-resolution image from one low-resolution image by deep learning are known. The target area extraction unit 120 periodically detects a target area at second timing. The second timing is less frequent than the first timing. A method of extracting a target area by the target area extraction unit 120 will be specifically described below.

The target area extraction unit 120 determines whether or not the vehicle included in the candidate area is a vehicle traveling in the same driving lane as that of the specific vehicle 1 or an adjacent lane (referred to as a neighboring vehicle) (Step S102).

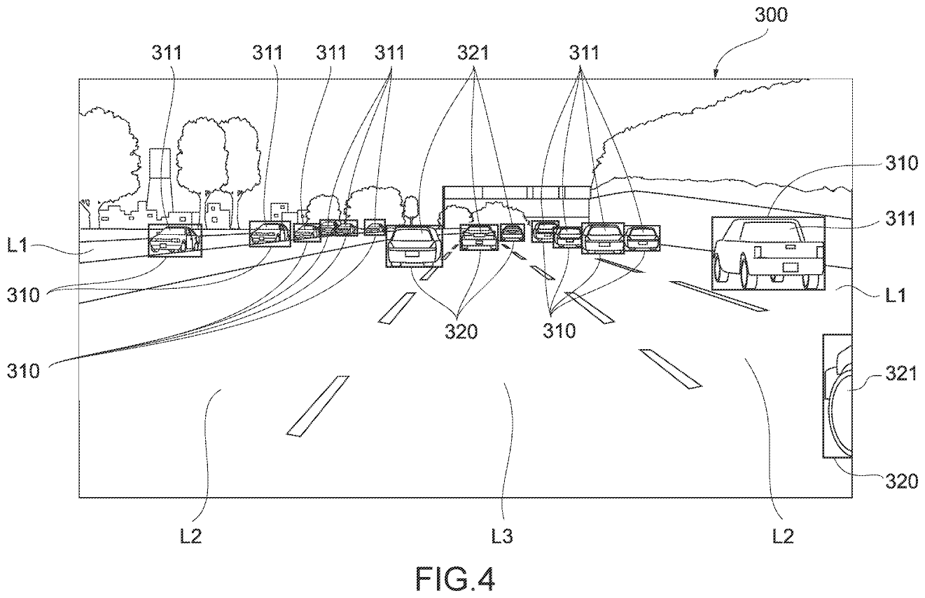

FIG. 4 schematically shows another example of the candidate area detected from the environment image.

Specifically, the target area extraction unit 120 extracts lanes L1, L2, and L3 from an environment image 300 using a known image analysis technology, and judges a positional relationship and distance of vehicles 311 and 321 included in candidate areas 310 and 320 with respect to the extracted lanes L1, L2, and L3. In the case where the vehicle 311 included in the candidate area 310 is not a neighboring vehicle for the specific vehicle 1, e.g., in the case where it is the vehicle 311 traveling in the lane L1 distant from the adjacent lane L2 adjacent to the driving lane L3 in which the specific vehicle 1 travels (referred to as a distant vehicle 311), the specific vehicle 1 does not execute automatic braking or the like directly due to this distant vehicle 311. In other words, it is after the distant vehicle 311 moves to the adjacent lane L2 and is regarded as a neighboring vehicle that the specific vehicle 1 executes automatic braking or the like directly due to the distant vehicle 311. For this reason, it is unnecessary to calculate the distance from the specific vehicle 1 to the distant vehicle 311 (NO in Step S102). Meanwhile, in the case where the vehicle 321 included in the candidate area 320 is the neighboring vehicle for the specific vehicle 1, there is a possibility that the specific vehicle 1 executes automatic braking or the like directly due to the neighboring vehicle 321. For this reason, the information processing apparatus 10 calculates the distance from the specific vehicle 1 to the neighboring vehicle 321 (YES in Step S102). Note that in the case where the neighboring vehicle 321 in the environment image 300 does not include a license plate (e.g., the lower right vehicle in FIG. 4), the information processing apparatus 10 may calculate the distance to the neighboring vehicle 321 using another method. For example, a method based on the coordinate position of the lower end of the image of the object (method of determining that the object is a closer object as the lower end thereof is closer to the lower part of the image and the object is a farther object as the lower end thereof is closer to the upper part of the image, on the basis of the principle of perspective) or a method of using the lidar apparatus 13 and the radar apparatus 12 can be used.

The target area extraction unit 120 judges environment information of surroundings of the imaging apparatus 11 (i.e., environment information of surroundings of the vehicle 1). The environment information indicates, for example, weather, illuminance, and/or luminance. Specifically, the target area extraction unit 120 determines whether or not the current timeframe is daytime (Step S103). For example, the target area extraction unit 120 may judges the current timeframe on the basis of the illuminance and/or luminance of the environment image. Alternatively, the target area extraction unit 120 may judge the current timeframe on the basis of the detection result of the illuminance sensor and/or luminance sensor mounted on the vehicle 1. Alternatively, the target area extraction unit 120 may judge the current timeframe on the basis of the actual time indicated by a clock or timer supplementarily. It is estimated that the image quality of the environment information is relatively high in daytime while it is estimated that the image quality of the environment information is relatively low in the evening or nighttime because the illuminance and/or luminance are insufficient. Note that since there are cases where the illuminance is low even during daytime, e.g., when traveling in a tunnel, it is better to perform the judgement of the timeframe based on the actual time, supplementarily.

The target area extraction unit 120 further determines whether or not the current weather is fine (Step S104). For example, the target area extraction unit 120 may judge the current weather on the basis of the illuminance and/or luminance of the environment image. Alternatively, the target area extraction unit 120 may judge the current weather on the basis of the detection result of the illuminance sensor and/or luminance sensor mounted on the vehicle 1. Alternatively, the target area extraction unit 120 may judge the current weather on the basis of whether or not a vibration sensor (rain sensor) installed on the windshield or the like has detected vibration caused by rain or snow. It is estimated that the image quality of the environment information is relatively high in fine weather, while it is estimated that the image quality of the environment information is relatively low in rainy weather or snow.

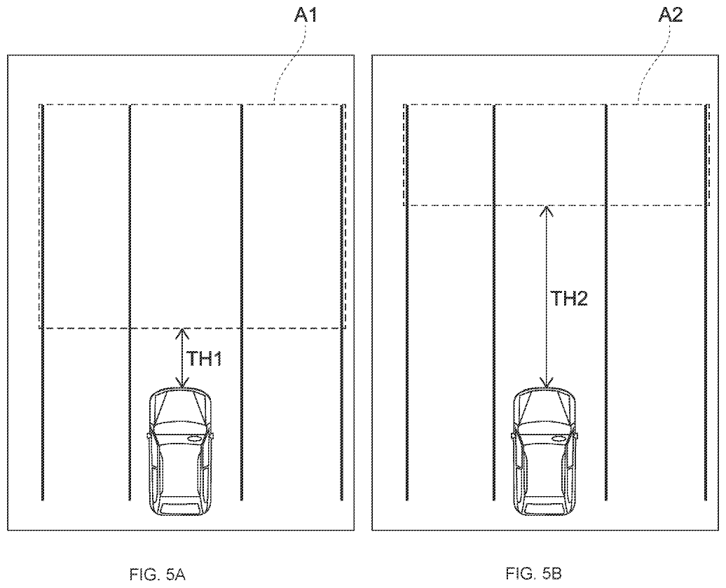

FIG. 5 is a diagram for describing a first threshold value and a second threshold value.

As shown in Part (A), the target area extraction unit 120 sets the threshold value of the distance for extracting the target area from the candidate area on the basis of the environment information of surroundings of the imaging apparatus 11 (i.e., environment information of surroundings of the vehicle 1). Specifically, the target area extraction unit 120 sets a first threshold value TH1 as a threshold value of the distance in a scene where the image quality of the environment image is estimated to be low on the basis of the environment information (weather, illuminance, and/or luminance, etc.) (Step S105). The scene where the image quality of the environment image is estimated to be low is, for example, a case where the current timeframe is not daytime (is evening or nighttime) (NO in Step S103) or a case where the current weather is not fine weather (is rainy weather or snow) (NO in Step S104). The first threshold value TH1 is, for example, 5 m.

Meanwhile, as shown in Part (B), the target area extraction unit 120 sets a second threshold value TH2 as a threshold value of the distance in the case where the image quality of the environment image is not estimated to be low (is estimated to be relatively high) on the basis of the environment information (weather, illuminance, and/or luminance, etc.) (Step S106). The scene where the image quality of the environment image is estimated to be high is, for example, a case where the current timeframe is daytime (YES in Step S103) or a case where the current weather is fine weather (YES in Step S104). The second threshold value TH2 is larger than the first threshold value TH1 and is, for example, 15 m. That is, the threshold value (the first threshold value TH1 or the second threshold value TH2) is variable.

The target area extraction unit 120 determines whether or not the distance from the vehicle 1 to the specific object included in the candidate area of the environment image (neighboring vehicle) is equal to or greater than the threshold value (i.e., the set first threshold value TH1 or second threshold value TH2) (Step S107). In other words, as shown in Part (A), the target area extraction unit 120 determines, in a scene where the image quality of the environment image is estimated to be low, the distance from the vehicle 1 to the neighboring vehicle is equal to or greater than the first threshold value TH1, i.e., the neighboring vehicle is traveling in a super-resolution area A1 farther than the first threshold value TH1. Alternatively, as shown in Part (B), the target area extraction unit 120 determines, in a scene where the image quality of the environment image is estimated to be high, the distance from the vehicle 1 to the neighboring vehicle is equal to or greater than the second threshold value TH2, i.e., the neighboring vehicle is traveling in a super-resolution area A2 farther than the second threshold value TH2.

For example, the target area extraction unit 120 only needs to judge the distance from the vehicle 1 to the neighboring vehicle on the basis of the size of the rectangle that is the candidate area. In the example of FIG. 3, the distance from the vehicle 1 to the neighboring vehicle 211 is larger as the size of the candidate area 210 is smaller, and the distance from the vehicle 1 to the neighboring vehicle 221 is shorter as the size of the candidate area 220 is larger. Note that the distance form the vehicle 1 to the neighboring vehicle may be calculated on the basis of not only the size of the rectangle that is the candidate area but also the vanishing point in the environment image in perspective or the ranging information generated by the radar apparatus 12 and/or the lidar apparatus 13.

The target area extraction unit 120 extracts, in the case where the distance from the vehicle 1 to the specific object included in the candidate area (neighboring vehicle) is equal to or greater than the threshold value (i.e., the set first threshold value TH1 or second threshold value TH2) (YES in Step S107), a target area from the candidate area including the neighboring vehicle (Step S108). The target area includes the license plate of the neighboring vehicle. The target area is a region that is a target of super-resolution processing. In short, the target area extraction unit 120 regards the license plate of the neighboring vehicle traveling a relatively long distance (threshold value or more) from the vehicle 1 as a target of super-resolution processing.

Meanwhile, the target area extraction unit 120 does not extract a target area from the candidate area in the case where the distance from the vehicle 1 to the specific object included in the candidate area (neighboring vehicle) is less than the threshold value (i.e., the set first threshold value TH1 or second threshold value TH2) (NO in Step S107). In short, the target area extraction unit 120 does not regard the license plate of the neighboring vehicle traveling a relatively short distance (less than the threshold value) from the vehicle 1 as a target of super-resolution processing.

In the example of FIG. 3, the target area extraction unit 120 extracts a target area 213 including a license plate 212 (Step S108) from the neighboring vehicle 211 included in the candidate area 210 having a small size (i.e., the vehicle 211 traveling a long distance) (YES in Step S107). Meanwhile, the target area extraction unit 120 does not extract a target area 223 including a license plate 222 from the neighboring vehicle 221 included in the candidate area 220 having a large size (that is, the vehicle 221 traveling a short distance) (NO in Step S107).

The super-resolution processing unit 130 generates a super-resolution image by performing super-resolution processing on the target area extracted from the candidate area of the environment image (i.e., area including the license plate) (Step S109). The super-resolution processing is a technology for generating a high-resolution image from a low-resolution image. The super-resolution processing unit 130 only needs to use, as the super-resolution processing, for example, a technology for generating a high-resolution image by synthesizing a plurality of low-resolution images that is continuous in time series or a technology for generating a high-resolution image from one low-resolution image by deep learning. The super-resolution processing unit 130 periodically executes the super-resolution processing at the second timing.

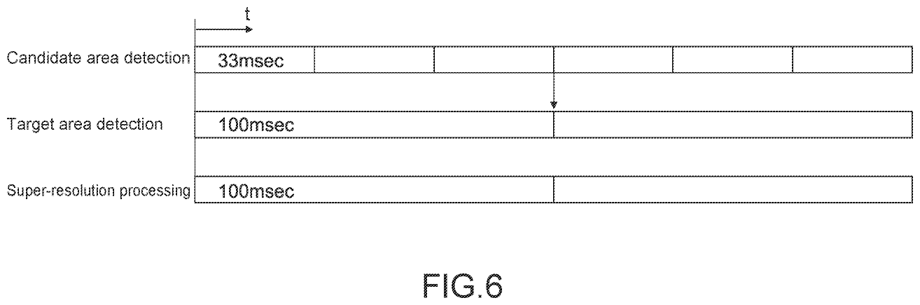

FIG. 6 schematically shows processing timings of a candidate area detection unit, a target area extraction unit, and a super-resolution processing unit.

As described above, the candidate area detection unit 110 periodically detects a candidate area at the first timing (Step S101). The target area extraction unit 120 periodically detects a target area at the second timing (Step S102 to Step S108). The super-resolution processing unit 130 periodically executes super-resolution processing at the second timing (Step S109). The second timing is less frequent than the first timing. For example, the first timing is every 33 milliseconds and the second timing is every 100 milliseconds, which is less frequent than every 33 milliseconds. Alternatively, the first timing is timing of 30 fps (frames per second), and the second timing is timing of 10 fps, which is less frequent than 30 fps. When the target area extraction unit 120 constantly detects a target area and the super-resolution processing unit 130 constantly executes super-resolution processing at the second timing of a relatively low frequency, it is possible to suppress an increase in processing load and a decrease in processing speed.

The license plate judgment unit 140 cuts out the license plate of the neighboring vehicle using a known image analysis technology from the super-resolution image generated by the super-resolution processing unit 130 (Step S109) and analyzes the characters of the license plate. The license plate judgment unit 140 judges the size of the license plate and/or the size of the characters on the license plate on the basis of the super-resolution processing unit 130 (Step S110).

Alternatively, in the case where the target area extraction unit 120 has not extracted a target area from the candidate area (NO in Step S107), the license plate judgment unit 140 cuts out the license plate of the neighboring vehicle using a known image analysis technology from the candidate area of the environment image and analyzes the characters of the license plate. The license plate judgment unit 140 judges the size of the license plate of the neighboring vehicle included in the candidate area and/or the size of the characters on the license plate (Step S110).

In short, the license plate judgment unit 140 judges the size of the license plate of the neighboring vehicle of the neighboring vehicle at a long distance and/or the size of the characters on the license plate from the super-resolution image. Meanwhile, the license plate judgment unit 140 judges the size of the license plate of the neighboring vehicle of the neighboring vehicle at a short distance and/or the size of the characters on the license plate from the environment image (image having a resolution lower than that of the super-resolution image).

The distance calculation unit 150 calculates the distance between the specific vehicle 1 and the neighboring vehicle on the basis of the size judged by the license plate judgment unit 140 (the size of the license plate and/or the size of the characters on the license plate) (Step S111).

### 3. Modified Example

In this embodiment, the vehicle 1 includes the information processing apparatus 10, the imaging apparatus 11, the radar apparatus 12, and/or the lidar apparatus 13 as onboard units. Instead, a roadside unit may include the information processing apparatus 10, the imaging apparatus 11, the radar apparatus 12, and/or the lidar apparatus 13. In this case, the imaging apparatus 11 of the roadside unit only needs to image the specific vehicle 1 and a neighboring vehicle to acquire an environment image, and the information processing apparatus 10 of the roadside unit only needs to calculate the distance between the specific vehicle 1 and the neighboring vehicle from the environment image. The present technology can be applied to s security camera system installed in a parking lot or the like instead of the roadside unit.

The super-resolution image generated by the super-resolution processing unit 130 (Step S109) and/or the characters of the license plate analyzed by the license plate judgment unit 140 (Step S110) may be stored in a non-volatile storage device in association with the environment image that the imaging apparatus 11 constantly acquires. In the case where the specific vehicle 1 includes the information processing apparatus 10 and the imaging apparatus 11 as in this embodiment, the data can be used as a drive recorder of the specific vehicle 1. In this case, the storage device only needs to be provided locally in the specific vehicle 1 or in a server apparatus connected to the specific vehicle 1 via a network. In the case where a roadside unit or a security camera system such as a parking lot includes the information processing apparatus 10 and the imaging apparatus 11 as in the modified example, the data can be used for safety purposes, such as verification of accidents in the field. In this case, the storage device only needs to be provided in a server apparatus connected to a roadside unit or a security camera system such as a parking lot via a network.

In this embodiment, the information processing apparatus 10 has extracted an are including a license plate as a target area that is a target of super-resolution processing and performed super-resolution processing thereon. The target of super-resolution processing is not limited to a license plate, and super-resolution processing may be performed on another object. For example, the information processing apparatus 10 may extract an area including a road sign as a target area that is a target of super-resolution processing and perform super-resolution processing thereon. The road sign is located at a high position and close to the road shoulder, e.g., on a support. For this reason, there is a high possibility that a road sign will appear in the upper left quarter area in the case of traveling in the left lane and the upper right quarter area in the case of traveling in the right lane, in the rectangular environment image. The information processing apparatus 10 may use, as a candidate area, an area in the environment image that appears frequently. In other words, the information processing apparatus 10 may constantly treat an area in the environment image that appears frequently (e.g., the upper right quarter area) as a candidate area instead of constantly and periodically detecting a candidate area as in this embodiment (Step S101). In this case, the information processing apparatus 10 only needs to extract an area including a road sign as a target area that is a target of super-resolution processing from this candidate area and perform super-resolution processing thereon.

Alternatively, the information processing apparatus 10 may extract an area including a parking frame of a parking lot as a target area that is a target of super-resolution processing and perform super-resolution processing thereon. In particular, in the case of a large parking lot, it is difficult to detect a distant parking frame in some cases. The information processing apparatus 10 only needs to perform super-resolution processing on the parking frame to determine whether or not the parking space is empty. This technology can be applied to an automated parking function in the case where the specific vehicle 1 is an automated driving vehicle.

### 4. Conclusion

With the increasing demand for vehicle safety in an advance driving support system (ADAS) and the development of automated driving vehicle technology, a technology for measuring a distance and a positional relationship between vehicles traveling on a road is being explored.

In order to execute automated driving or execute automatic braking or the like in non-automated driving, the information processing apparatus 10 calculates the distance between the vehicle 1 (referred to also as a specific vehicle) and a neighboring vehicle (vehicle traveling in the same driving lane as that of the specific vehicle 1 or an adjacent lane). Specifically, the information processing apparatus 10 judges the size of the license plate of the neighboring vehicle and/or the size of the characters on the license plate, and calculates the distance from the vehicle 1 to the neighboring vehicle on the basis of the judged size. The size of the vehicle varies depending on the respective types, but the size of the license plate and/or the size of the characters on the license plate are uniformly defined by standards. For this reason, by detecting the size of the license plate of the neighboring vehicle and/or the size of the characters on the license plate, it is possible to calculate the distance from the vehicle 1 to the neighboring vehicle.

Meanwhile, the size of the license plate and/or the size of the characters on the license plate are smaller than the back surface of the vehicle. For this reason, it is difficult to extract a license plate and/or characters of the license plate from the environment image and calculate the size accurately in some cases for distance vehicles or vehicles at a relatively short distance depending on the weather and the timeframe.

In order to extract a license plate and/or characters of the license plate from an environment image and accurately calculate the size, a method of performing super-resolution processing on the entire environment image is conceivable. For example, a technology for generating a high-resolution image by synthesizing a plurality of low-resolution images that is continuous in time series and a technology for generating a high-resolution image from one low-resolution image by deep learning are known. However, in both the method of synthesizing in time series and the method of using deep learning, the amount of calculation for super-resolution processing is enormous. For this reason, in the field of in-vehicle sensing cameras, which requires real-time processing of a large number of recognition algorithms, it is difficult to apply super-resolution to the entire environment image in terms of processing load and processing speed.

On the other hand, in this embodiment, the information processing apparatus 10 extracts the minimum area including only the license plate as much as possible from the environment image as a target area instead of the entire environment image and performs super-resolution processing thereon. As a result, it is possible to suppress an increase in processing load and a decrease in processing speed.

Further, in this embodiment, the information processing apparatus 10 does not all license plates as a target area for super-resolution processing, but extracts the license plate of a neighboring vehicle (vehicle traveling in the same driving lane as that of the specific vehicle 1 or an adjacent lane) as a target area for super-resolution processing. This is because the vehicle 1 does not execute automatic braking or the like directly due to a vehicle traveling in a lane distant from the adjacent lane (distant vehicle). In other words, it is after the distant vehicle moves to the adjacent lane and is regarded as a neighboring vehicle that the vehicle 1 executes automatic braking or the like directly due to the distant vehicle. For this reason, it is unnecessary to perform super-resolution processing on the license plate of the distant vehicle. As a result, it is possible to further suppress an increase in processing load and a decrease in processing speed.

Further, in this embodiment, the information processing apparatus 10 does not extract license plates of all neighboring vehicles as a target area for super-resolution processing, but extracts a license plate of a neighboring vehicle at a relatively long distance as a target area for super-resolution processing. This is because a license plate of a neighboring vehicle at a relatively short distance is relatively sharp in the environment image. For this reason, there is a high possibility that the license plate can be accurately extracted from an environment image with a relatively low resolution without performing super-resolution processing. As a result, it is possible to further suppress an increase in processing load and a decrease in processing speed.

Further, in this embodiment, the information processing apparatus 10 variably sets the threshold value of the distance for extracting the target area from the candidate area on the basis of environment information (weather, illuminance, and/or luminance). As a result, the information processing apparatus 10 performs, in a scene where the image quality of the environment image is estimated to be low (nighttime, rainy weather, or the like), super-resolution processing on the license plate of a neighboring vehicle at a relatively short distance from the vehicle 1. Meanwhile, the information processing apparatus 10 does not execute, in a scene where the image quality of the environment image is estimated to be high (daytime, fine weather, or the like), super-resolution processing on the license plate of a neighboring vehicle at a relatively short distance from the vehicle 1. As a result, it is possible to ensure the safety in a scene where the image quality of the environment image is estimated to be low, while suppressing, in a scene where the image quality of the environment image is estimated to be high, an increase in processing load and a decrease in processing speed.

It should be noted that the present disclosure may take the following configurations.
(1) An information processing apparatus, including:
a candidate area detection unit that detects a candidate area including a specific object from an environment image acquired by an imaging apparatus;
a target area extraction unit that extracts a target area from the candidate area, the target area being a target of super-resolution processing; and
a super-resolution processing unit that generates a super-resolution image by performing super-resolution processing on the target area.
(2) The information processing apparatus according to (1) above, in which
the target area extraction unit
   determines whether or not a distance to the object is equal to or greater than a threshold value, and
   extracts, upon determining that the distance is equal to or greater than the threshold value, the target area from the candidate area.
(3) The information processing apparatus according to (2) above, in which
   the threshold value is variable, and
   the target area extraction unit sets the threshold value on the basis of environment information of surroundings of the imaging apparatus.
(4) The information processing apparatus according to (3) above, in which
   the environment information indicates weather, illuminance, and/or luminance.
(5) The information processing apparatus according to (3) or (4) above, in which
   the target area extraction unit
      sets, where image quality of the environment image is estimated to be low on the basis of the environment information, a first threshold value as the threshold value, and
      sets, where the image quality is not estimated to be low, a second threshold value larger than the first threshold value as the threshold value.
(6) The information processing apparatus according to any one of (1) to (5) above, in which
   the object is at least part of a vehicle, and
   the target area includes a license plate of the vehicle.
(7) The information processing apparatus according to any one of (1) to (5) above, in which
   the target area includes a license plate of a neighboring vehicle that is a vehicle traveling in the same driving lane as that of the specific vehicle or an adjacent lane.
(8) The information processing apparatus according to (7) above, in which
   the target area extraction unit determines, as a distance to the object, whether or not a distance from the specific vehicle to the neighboring vehicle is equal to or greater than the threshold value.
(9) The information processing apparatus according to (7) or (8) above, further including:
   a license plate judgment unit that judges, on the basis of the super-resolution image generated by the super-resolution processing unit, a size of the license plate of the neighboring vehicle and/or a size of characters of the license plate; and
   a distance calculation unit that calculates a distance between the specific vehicle and the neighboring vehicle on the basis of the size.
(10) The information processing apparatus according to any one of (7) to (9) above, in which
   the target area extraction unit refrains, upon determining that the distance to the object is less than the threshold value, from extracting the target area from the candidate area,
   the license plate judgment unit judges a size of the license plate of the neighboring vehicle and/or a size of characters of the license plate included in the candidate area, and
   the distance calculation unit calculates a distance between the specific vehicle and the neighboring vehicle on the basis of the size.
(11) The information processing apparatus according to any one of (1) to (10) above, in which
   the candidate area detection unit periodically detects the candidate area at first timing, and
   the target area extraction unit periodically extracts the target area at second timing that is less frequent than the first timing.
(12) The information processing apparatus according to (11) above, in which
   the super-resolution processing unit periodically generates the super-resolution image at the second timing.
(13) The information processing apparatus according to any one of (1) to (12) above, in which
   the imaging apparatus is a monocular camera.
(14) The information processing apparatus according to any one of (7) to (10) above, in which
   the specific vehicle includes the information processing apparatus and the imaging apparatus.
(15) The information processing apparatus according to (14) above, in which
   the specific vehicle is an automated driving vehicle.
(16) The information processing apparatus according to any one of (1) to (13) above, in which
   the information processing apparatus and the imaging apparatus are provided in a roadside unit.
(17) An information processing method, including:
   extracting a candidate area including a specific object from an environment image acquired by an imaging apparatus;
   extracting a target area from the candidate area, the target area being a target of super-resolution processing; and
   generating a super-resolution image by performing super-resolution processing on the target area.
(18) An information processing program that causes a processor of an information processing apparatus to operates as:
   a candidate area detection unit that detects a candidate area including a specific object from an environment image acquired by an imaging apparatus;
   a target area extraction unit that extracts a target area from the candidate area, the target area being a target of super-resolution processing; and
   a super-resolution processing unit that generates a super-resolution image by performing super-resolution processing on the target area.
(19) A non-transitory computer-readable recording medium that records an information processing program causing a processor of an information processing apparatus to operate as:
   a candidate area detection unit that detects a candidate area including a specific object from an environment image acquired by an imaging apparatus;
   a target area extraction unit that extracts a target area from the candidate area, the target area being a target of super-resolution processing; and
   a super-resolution processing unit that generates a super-resolution image by performing super-resolution processing on the target area.

Although embodiments of the present technology and modified examples have been described above, it goes without saying that the present technology is not limited to the above-mentioned embodiments and various modifications can be made without departing from the essence of the present technology.

### REFERENCE SIGNS LIST

1 vehicle
10 information processing apparatus
11 imaging apparatus
110 candidate area detection unit
12 radar apparatus
120 target area extraction unit
13 lidar apparatus
130 super-resolution processing unit
140 license plate judgment unit
150 distance calculation unit

1. An information processing apparatus, comprising:
a candidate area detection unit that detects a candidate area including a specific object from an environment image acquired by an imaging apparatus;
a target area extraction unit that extracts a target area from the candidate area, the target area being a target of super-resolution processing; and
a super-resolution processing unit that generates a super-resolution image by performing super-resolution processing on the target area.

2. The information processing apparatus according to claim 1, wherein
the target area extraction unit
determines whether or not a distance to the object is equal to or greater than a threshold value, and
extracts, upon determining that the distance is equal to or greater than the threshold value, the target area from the candidate area.

3. The information processing apparatus according to claim 2, wherein
the threshold value is variable, and
the target area extraction unit sets the threshold value on a basis of environment information of surroundings of the imaging apparatus.

4. The information processing apparatus according to claim 3, wherein
the environment information indicates weather, illuminance, and/or luminance.

5. The information processing apparatus according to claim 3, wherein
the target area extraction unit
sets, where image quality of the environment image is estimated to be low on a basis of the environment information, a first threshold value as the threshold value, and
sets, where the image quality is not estimated to be low, a second threshold value larger than the first threshold value as the threshold value.

6. The information processing apparatus according to claim 2, wherein
the object is at least part of a vehicle, and
the target area includes a license plate of the vehicle.

7. The information processing apparatus according to claim 6, wherein
the target area includes a license plate of a neighboring vehicle that is a vehicle traveling in the same driving lane as that of the specific vehicle or an adjacent lane.

8. The information processing apparatus according to claim 7, wherein
the target area extraction unit determines, as a distance to the object, whether or not a distance from the specific vehicle to the neighboring vehicle is equal to or greater than the threshold value.

9. The information processing apparatus according to claim 7, further comprising:
a license plate judgment unit that judges, on a basis of the super-resolution image generated by the super-resolution processing unit, a size of the license plate of the neighboring vehicle and/or a size of characters of the license plate; and
a distance calculation unit that calculates a distance between the specific vehicle and the neighboring vehicle on a basis of the size.

10. The information processing apparatus according to claim 9, wherein
the target area extraction unit refrains, upon determining that the distance to the object is less than the threshold value, from extracting the target area from the candidate area,
the license plate judgment unit judges a size of the license plate of the neighboring vehicle and/or a size of characters of the license plate included in the candidate area, and
the distance calculation unit calculates a distance between the specific vehicle and the neighboring vehicle on a basis of the size.

11. The information processing apparatus according to claim 1, wherein
the candidate area detection unit periodically detects the candidate area at first timing, and
the target area extraction unit periodically extracts the target area at second timing that is less frequent than the first timing.

12. The information processing apparatus according to claim 11, wherein
the super-resolution processing unit periodically generates the super-resolution image at the second timing.

13. The information processing apparatus according to claim 1, wherein
the imaging apparatus is a monocular camera.

14. The information processing apparatus according to claim 7, wherein
the specific vehicle includes the information processing apparatus and the imaging apparatus.

15. The information processing apparatus according to claim 14, wherein
the specific vehicle is an automated driving vehicle.

16. The information processing apparatus according to claim 1, wherein
the information processing apparatus and the imaging apparatus are provided in a roadside unit.

17. An information processing method, comprising:
extracting a candidate area including a specific object from an environment image acquired by an imaging apparatus;
extracting a target area from the candidate area, the target area being a target of super-resolution processing; and
generating a super-resolution image by performing super-resolution processing on the target area.

18. An information processing program that causes a processor of an information processing apparatus to operates as:
a candidate area detection unit that detects a candidate area including a specific object from an environment image acquired by an imaging apparatus;
a target area extraction unit that extracts a target area from the candidate area, the target area being a target of super-resolution processing; and
a super-resolution processing unit that generates a super-resolution image by performing super-resolution processing on the target area.
